(19) United States
(12) Patent Application Publication
(10) Pub. No.: US 2005/0278704 A1
(43) Pub. Date: Dec. 15, 2005

(54) Method, apparatus, and program storage device for detecting failures in data flow in high-availability storage systems

(75) Inventor: David S. Ebsen, Chaska, MN (US)

Correspondence Address: Crawford Maunu PLLC;Suite 390, 1270 Northland Drive, St. Paul, MN, 55120, US

(73) Assignee: XIOtech Corporation

(21) Appl. No.: 10/865,191

(22) Filed: Jun. 10, 2004

(51) Int. Cl. G06F 9/44

(52) U.S. Cl. 717/128

(57) ABSTRACT

A method, apparatus, and program storage devices that can detect failures in data flow in high-availability storage systems is disclosed. The present invention provides a plurality of software layers that are to be executed in a predetermined order. An equation is implemented in each of the plurality of software layers. The equation provides a solution for determining when the plurality of software layers were executed in the predetermined order.

### BACKGROUND OF THE INVENTION

1. Field of the Invention

This invention relates in general to flow control error detection, and more particularly to a method, apparatus, and a program storage device for detecting failures in data flow in high-availability storage systems.

2. Description of Related Art

In conventional storage, data resides on storage arrays that are controlled by the server on which the applications that uses the data are hosted. Multiple servers are connected to each other over a local area network (LAN). The rapid growth in data intensive applications continues to fuel the demand for raw data storage capacity. Applications such as data warehousing, data mining, on-line transaction processing, and multimedia Internet and intranet browsing are resulting in the near doubling of the total storage capacity shipped on an annual basis.

The storage of large amounts of data in so-called mass storage systems is becoming a common practice. Mass storage systems typically include storage devices coupled to file servers on data networks. Users in the network communicate with the file servers for access to the data. The file servers are typically connected to specific storage devices via data channels. The data channels are usually implemented with point-to-point communication protocols designed for managing storage transactions.

As the amount of storage increases, and the number of file servers in communication networks grows, the concept of a storage area network (SAN) has arisen. Storage area networks connect a number of mass storage systems in a communication network, which is optimized for storage transactions. For example, Fibre Channel arbitrated loop (FC-AL) networks are being implemented as SANs. The SANs support many point-to-point communication sessions between users of the storage systems and the specific storage systems on the SAN.

A SAN, or storage area network, is a dedicated network that is separate from LANs and WANs. It generally serves to interconnect the storage-related resources that are connected to one or more servers. It is often characterized by its high interconnection data rates (Gigabits/sec) between member storage peripherals and by its highly scalable architecture. Though typically spoken of in terms of hardware, SANs very often include specialized software for their management, monitoring and configuration.

SANs can provide many benefits. Centralizing data storage operations and their management is certainly one of the chief reasons that SANs are being specified and deployed today. Administrating all of the storage resources in high-growth and mission-critical environments can be daunting and very expensive. SANs can dramatically reduce the management costs and complexity of these environments while providing significant technical advantages.

SANs can be based upon several different types of high-speed interfaces. In fact, many SANs today use a combination of different interfaces. Currently, Fibre Channel serves as the de facto standard being used in most SANs. Fibre Channel is an industry-standard interconnect and high-performance serial I/O protocol that is media independent and supports simultaneous transfer of many different protocols. Additionally, SCSI interfaces are frequently used as sub-interfaces between internal components of SAN members, such as between raw storage disks and a RAID controller.

Fibre Channel is structured in independent layers, as are other networking protocols. The layers define physical media and transmission rates including cables and connectors, drivers, transmitters, and receivers, encoding schemes, the framing protocol and flow control. Fibre Channel provides a logical system of communication called Class of Service that is allocated by various protocols.

SANs are built up from unique hardware components. These components are configured together to form the physical SAN itself and usually include RAID storage systems, hubs, switches, bridges, servers, backup devices, interface cards and cabling.

More than ever before, software is playing a vital role in the successful deployment of SANs. Much of the technology, and many of the features, provided by SANs are actually embedded in its software. SANs today can become rather complex in both their design and implementation. Adding to this are issues relating to their configuration, resource allocation and monitoring. These tasks and concerns have led to a need to proactively manage SANs, their client servers and their combined resources. These needs have led to this new category of software that has been specifically developed to perform these functions and more. Though somewhat recent in its development, SAN management software borrows heavily from the ideas, functions and benefits that are mature and available for traditional LANs and WANs.

High-availability storage systems form the foundation for today's networked data solutions where continuous high-speed access to information is becoming an essential requirement for the day-to-day running of almost any modern enterprise. One of the most difficult design challenges in high availability storage systems is to actually detect failures. For example, being able to know if data can actually flow is important because storage units have no control over server requests.

It can be seen then that there is a need for a method, apparatus, and a program storage device for detecting failures in data flow in high-availability storage systems.

### SUMMARY OF THE INVENTION

To overcome the limitations described above, and to overcome other limitations that will become apparent upon reading and understanding the present specification, the present invention discloses a method, apparatus, and a program storage device for detecting failures in data flow in high-availability storage systems.

The present invention solves the above-described problems by implementing an equation in each of a plurality of software layers. The equation provides a solution for determining when the plurality of software layers are executed in the predetermined order.

A method in accordance with the principles of the present invention includes providing a plurality of software layers to be executed in a predetermined order and implementing an equation in each of the plurality of software layers for providing a solution for determining when the plurality of software layers were executed in the predetermined order.

In another embodiment of the present invention, a processing system is provided. The processing system includes memory for storing data therein and a processor, coupled to the memory, for processing data, the processor being further configured for detecting failures in data flow by implementing an equation in each of a plurality of software layers for providing a solution for determining when the plurality of software layers are executed in a predetermined order.

In another embodiment of the present invention, a program storage device is provided. The program storage device includes program instructions executable by a processing device to perform operations for detecting failures in data flow, the operations including providing a plurality of software layers to be executed in a predetermined order and implementing an equation in each of the plurality of software layers for providing a solution for determining when the plurality of software layers were executed in the predetermined order.

In another embodiment of the present invention, another processing system is provided. This processing system includes means for storing data and means, coupled to the means for storing data, for processing data, the means for processing data being further configured for detecting failures in data flow by implementing means in each of a plurality of software layers for providing a solution for determining when the plurality of software layers are executed in a predetermined order.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage system according to an embodiment of the present invention;

FIG. 2 illustrates a networked storage system according to an embodiment of the present invention;

FIG. 3 illustrates the firmware levels in a high-availability storage system according to an embodiment of the present invention;

FIG. 4 illustrates an example of a flow control error;

FIG. 5 illustrates a process for detecting failures in data flow in high-availability storage systems according to an embodiment of the present invention; and

FIG. 6 illustrates a component or system is a high availability storage system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus, and a program storage device for detecting failures in data flow in high-availability storage systems. The present invention provides an equation in each of a plurality of software layers. The equation provides a solution for determining when the plurality of software layers are executed in the predetermined order.

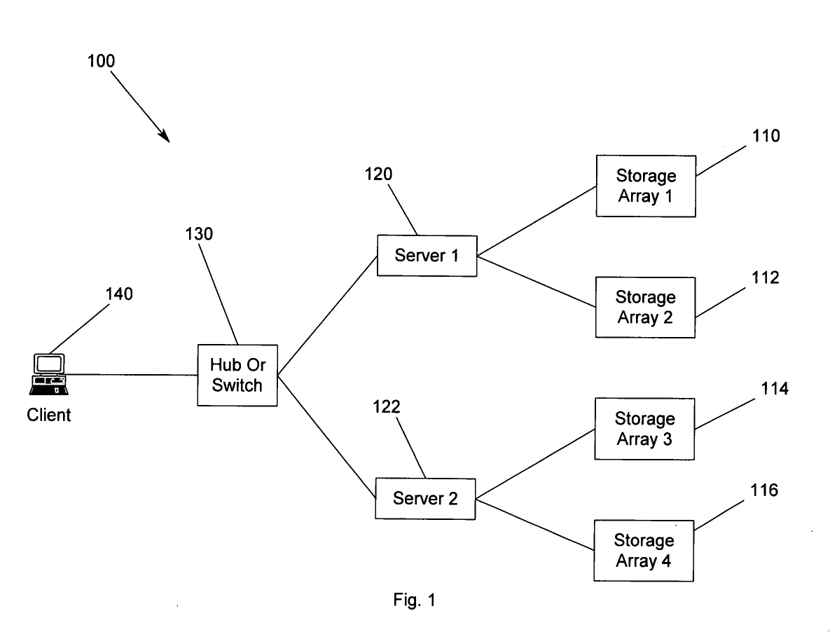

FIG. 1 illustrates a storage system 100 according to an embodiment of the present invention. In FIG. 1, data resides on storage arrays 110-116. The storage arrays 110-116 are controlled by one of servers 120, 122 on which the applications that use the data are hosted. Multiple servers 120, 122 are connected to each other over a local area network (LAN) formed using hub or switch 130. A client 140 is coupled to the LAN 130 and therefore may access data on the storage arrays 110-116 via the servers 120, 122.

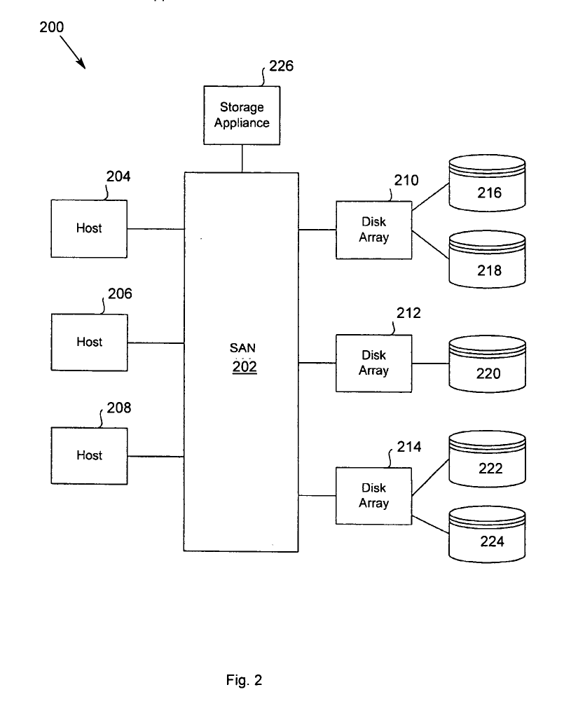

FIG. 2 illustrates a networked storage system 200 according to an embodiment of the present invention. In FIG. 2, a storage area network 202 provides a set of hosts (e.g., servers or workstations) 204, 206, 208 that may be coupled to a pool of storage devices (e.g., disks). In SCSI parlance, the hosts may be viewed as “initiators” and the storage devices may be viewed as “targets.” A storage pool may be implemented, for example, through a set of storage arrays or disk arrays 210, 212, 214. Each disk array 210, 212, 214 further corresponds to a set of disks. In this example, first disk array 210 corresponds to disks 216, 218, second disk array 212 corresponds to disk 220, and third disk array 214 corresponds to disks 222, 224. Rather than enabling all hosts 204-208 to access all disks 216-224, it is desirable to enable the dynamic and invisible allocation of storage (e.g., disks) to each of the hosts 204-208 via the disk arrays 210, 212, 214. In other words, physical memory (e.g., physical disks) may be allocated through the concept of virtual memory (e.g., virtual disks). This allows one to connect heterogeneous initiators to a distributed, heterogeneous set of targets (storage pool) in a manner enabling the dynamic and transparent allocation of storage.

The concept of virtual memory has traditionally been used to enable physical memory to be virtualized through the translation between physical addresses in physical memory and virtual addresses in virtual memory. Recently, the concept of “virtualization” has been implemented in storage area networks through various mechanisms. Virtualization converts physical storage and virtual storage on a storage network. The hosts (initiators) see virtual disks as targets. The virtual disks represent available physical storage in a defined but somewhat flexible manner. Virtualization provides hosts with a representation of available physical storage that is not constrained by certain physical arrangements/allocation of the storage.

One early technique, Redundant Array of Independent Disks (RAID), provides some limited features of virtualization. Various RAID subtypes have been implemented. In RAID1, a virtual disk may correspond to two physical disks 216, 218 which both store the same data (or otherwise support recovery of the same data), thereby enabling redundancy to be supported within a storage area network. In RAID0, a single virtual disk is striped across multiple physical disks. Some other types of virtualization include concatenation, sparing, etc. Some aspects of virtualization have recently been achieved through implementing the virtualization function in various locations within the storage area network. Three such locations have gained some level of acceptance: virtualization in the hosts (e.g., 204-208), virtualization in the disk arrays or storage arrays (e.g., 210-214), and virtualization in a storage appliance 226 separate from the hosts and storage pool. Unfortunately, each of these implementation schemes has undesirable performance limitations.

Virtualization in the storage array involves the creation of virtual volumes over the storage space of a specific storage subsystem (e.g., disk array). Creating virtual volumes at the storage subsystem level provides host independence, since virtualization of the storage pool is invisible to the hosts. In addition, virtualization at the storage system level enables optimization of memory access and therefore high performance. However, such a virtualization scheme typically will allow a uniform management structure only for a homogenous storage environment and even then only with limited flexibility. Further, since virtualization is performed at the storage subsystem level, the physical-virtual limitations set at the storage subsystem level are imposed on all hosts in the storage area network. Moreover, each storage subsystem (or disk array) is managed independently. Virtualization at the storage level therefore rarely allows a virtual volume to span over multiple storage subsystems (e.g., disk arrays), thus limiting the scalability of the storage-based approach.

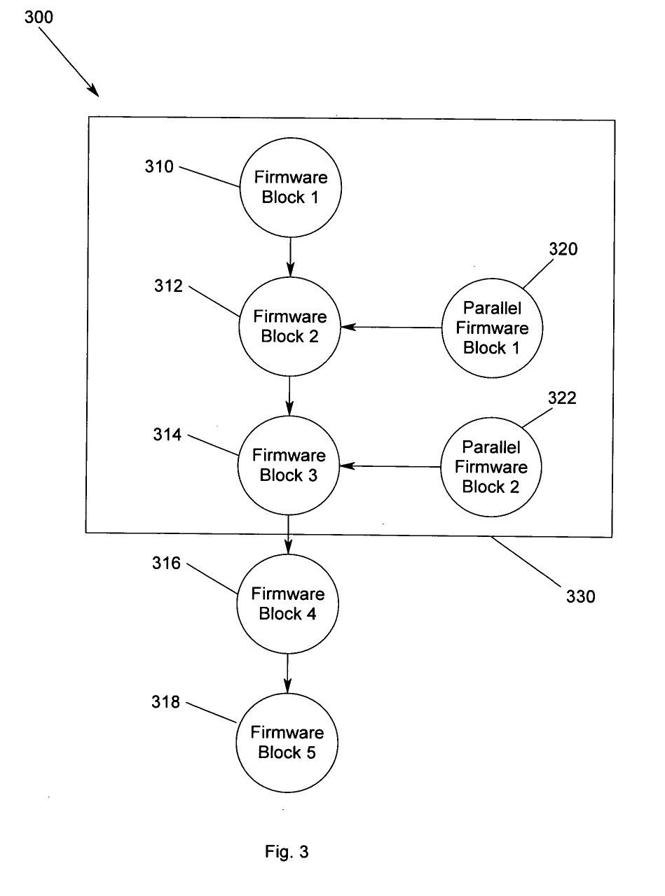

FIG. 3 illustrates the firmware levels in a high-availability storage system 300 according to an embodiment of the present invention. Firmware is one type of lower layer in processor systems. Firmware refers to processor routines that are stored in non-volatile memory structures such as read only memories (ROMs), flash memories, and the like. These memory structures preserve the code stored in them even when power is shut off. One of the principle uses of firmware is to provide the routines that control a computer system when it is powered up from a shut down state, before volatile memory structures have been tested and configured. The process by which a computer is brought to its operating state from a powered down or powered off state is referred to as bootstrapping. Firmware routines may also be used to reinitialize or reconfigure the computer system following various hardware events and to handle certain platform events like system interrupts.

In FIG. 3, five firmware levels 310, 312, 314, 316, 318 are shown in the high-availability storage system. Further, there may be parallel firmware blocks 320, 322 that operate at the same level as another firmware layer, e.g., 312, 314 respectively. However, those skilled in the art will recognize that the present invention is not meant to be limited to any particular number of firmware levels or firmware hierarchy. At least one of the firmware, e.g. firmware blocks 310, 312, 314, 320, 322, may be in a host bus adapters (HBAs), SAN switches or any other component 330 of the high-availability storage system.

In a high-availability storage system, sublayers or components of the firmware and operating system may be executing on different processors in possibly different hardware or in different threads on the same processor. If an error is encountered, the other processes may continue without knowledge of the error. The error may be such that continued execution by the other processors propagates the error and causes further damage such as corrupted data. In a multiprocessor system, an error is may be more difficult to handle because the layers may not be able to communicate effectively. Nevertheless, continued execution of firmware blocks when an error has occurred, whether in a multiprocessor system or in multiple-threaded system, processes continue operating without knowledge of the error thereby propagating errors that cause further errors in the system.

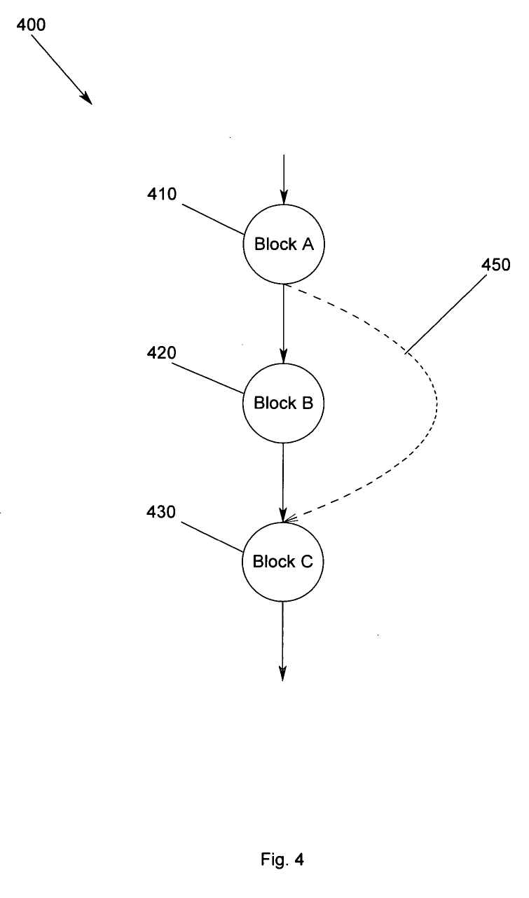

FIG. 4 illustrates an example of a flow control error 400. In FIG. 4, a straight line execution of firmware blocks A 410, B 420 and C 430 is expected. However, FIG. 4 shows that flow is incorrectly routed 450 from the end of block A 410 to the beginning of an incorrect block, i.e., block C 430. In this instance, the correct sequence of steps were not performed in the proper order. Yet, without a method or device for detecting failures in data flow in high-availability storage systems, detection of the error may go undetected.

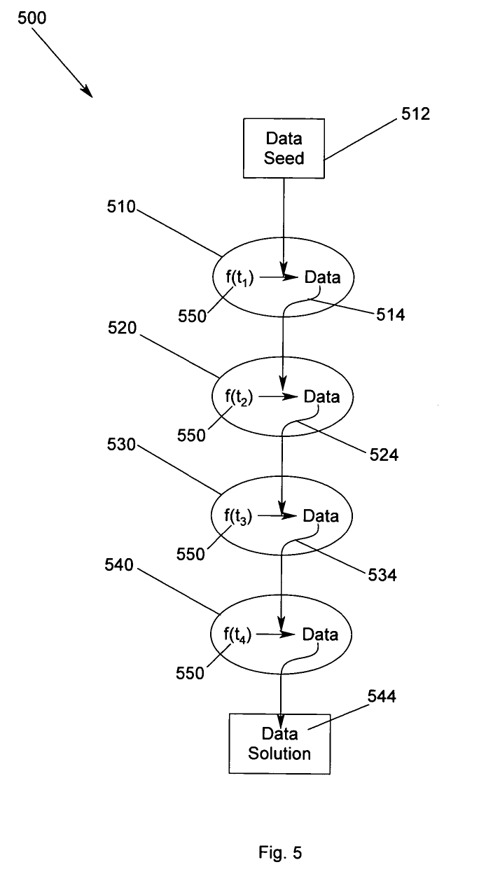

FIG. 5 illustrates a process 500 for detecting failures in data flow in high-availability storage systems according to an embodiment of the present invention. FIG. 5 shows four layers of firmware 510, 520, 530, 540. In FIG. 5, an equation 550, such as a differential equation, is implemented in each software layer 510, 520, 530, 540. Data 512 is provided to the first layer 510 and at the proper time, execution of the equation will yield a unique solution 514. This solution allows a confident measure of the health of the system. The solution at each level 524, 534, 544 may be reviewed to determine whether the solution is correct. Alternatively, the final data solution 544 may be reviewed to determine whether it is correct. Thus, the final solution 544 provides an indicator of whether the correct steps were executed in the proper order.

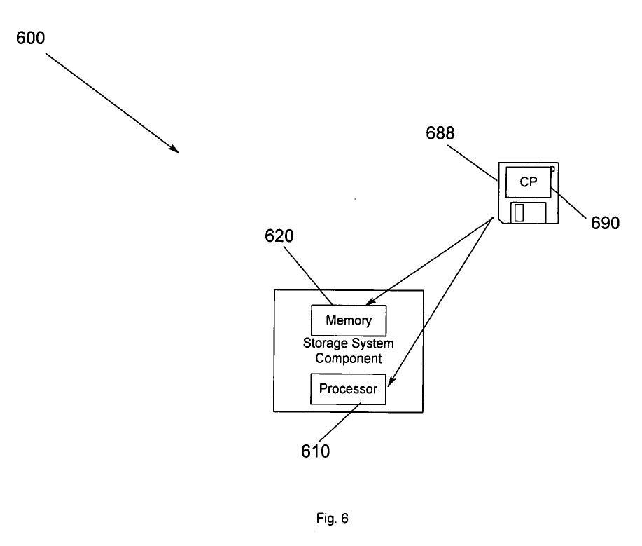

FIG. 6 illustrates a component or system 600 is a high availability storage system according to an embodiment of the present invention. The system 600 may, for example, represent a storage device or storage array 110-116, server 120-122, or hub/switch 130 as illustrated in FIG. 1, or SAN 202, disk arrays 210-214, or disk drives 216-218, 220, or 222-224. However, the present invention is not meant to be limited to implementation within any particular hardware system. Rather, the process illustrated with reference to FIGS. 1-5 may be implemented in any component of a storage system. The system 600 includes a processor 610 and memory 620. The processor controls and processes data for the storage system component 600. The process illustrated with reference to FIGS. 1-5 may be tangibly embodied in a computer-readable medium or carrier, e.g. one or more of the fixed and/or removable data storage devices 688 illustrated in FIG. 6, or other data storage or data communications devices. The computer program 690 may be loaded into memory 620 to configure the processor 610 for execution. The computer program 690 include instructions which, when read and executed by a processor 610 of FIG. 6 causes the processor 610 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A method for detecting failures in data flow, comprising:
providing a plurality of software layers to be executed in a predetermined order; and
implementing an equation in each of the plurality of software layers for providing a solution for determining when the plurality of software layers were executed in the predetermined order.

2. The method of claim 1 further comprising comparing the solution to a reference to determine whether the plurality of software layers were executed in the predetermined order.

3. The method of claim 1, wherein the implementing the equation comprises implementing a differential equation in each of the plurality of software layers.

4. The method of claim 1 further comprising providing data to the plurality of software layers, processing the data in the plurality of software layers to generate the solution.

5. The method of claim 4 further comprising comparing the solution to a reference to determine whether the plurality of software layers were executed in the predetermined order.

6. A processing system, comprising:
memory for storing data therein; and
a processor, coupled to the memory, for processing data, the processor being further configured for detecting failures in data flow by implementing an equation in each of a plurality of software layers for providing a solution for determining when the plurality of software layers are executed in a predetermined order.

7. The processing system of claim 6, wherein the processor compares the solution to a reference to determine whether the plurality of software layers were executed in the predetermined order.

8. The processing system of claim 6, wherein the processor implements a differential equation in each of the plurality of software layers.

9. The processing system of claim 6, wherein the processor processes data in the plurality of software layers using the equation to generate the solution.

10. The processing system of claim 9, wherein the processor compares the solution to a reference to determine whether the plurality of software layers were executed in the predetermined order.

11. The processing system of claim 9, wherein the processor is provided in a component of a storage system.

12. A program storage device, comprising:
program instructions executable by a processing device to perform operations for detecting failures in data flow, the operations comprising:
providing a plurality of software layers to be executed in a predetermined order; and
implementing an equation in each of the plurality of software layers for providing a solution for determining when the plurality of software layers were executed in the predetermined order.

13. The program storage device of claim 12 further comprising comparing the solution to a reference to determine whether the plurality of software layers were executed in the predetermined order.

14. The program storage device of claim 12, wherein the implementing the equation comprises implementing a differential equation in each of the plurality of software layers.

15. The program storage device of claim 12 further comprising providing data to the plurality of software layers, processing the data in the plurality of software layers to generate the solution.

16. The program storage device of claim 15 further comprising comparing the solution to a reference to determine whether the plurality of software layers were executed in the predetermined order.

17. A processing system, comprising:
means for storing data; and
means, coupled to the means for storing data, for processing data, the means for processing data being further configured for detecting failures in data flow by implementing means in each of a plurality of software layers for providing a solution for determining when the plurality of software layers are executed in a predetermined order.
